(19) United States
(12) Patent Application Publication
(10) Pub. No.: US 2009/0293724 A1
(43) Pub. Date: Dec. 3, 2009

(54) WATER EXTRACTOR AND A METHOD OF EXTRACTING WATER

(76) Inventor: Walter IVISON, Belrose New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/261,585

(22) Filed: Oct. 30, 2008

(30) Foreign Application Priority Data
May 30, 2008 (AU) 2008902751

(51) Int. Cl. B01D 53/26

(52) U.S. Cl. 95/288; 55/421

(57) ABSTRACT

A water extraction system having a cooling system adapted to cool air to below the dew point, the cooling system including an absorption chiller 1.002 including a heat source 1.004, the system includes an air/heat transfer fluid heat exchanger 1.016, and a water collector 1.022 arranged to collect water from the air/heat transfer fluid heat exchanger. The air/heat transfer fluid heat exchanger 1.016 is adapted to cool the air below the dew point. The chiller can include a heat input in the form of a gas burner or a solar collector.

### FIELD OF THE INVENTION

This invention relates to improvements in atmospheric water extraction.

### BACKGROUND OF THE INVENTION

Air conditioning systems sometimes produce water as a waste product in higher humidity conditions, but such equipment is not adapted to the production of water at lower humidity levels because the system does not consistently cool the air below the dew point at lower humidity levels. For example, an air conditioner may typically cool the room temperature to a steady state temperature of about 22° C., while the dew point can be several degrees less, so that, where the dew point is below the operating temperature of the air conditioning system, the system will not produce useful quantities of water.

The atmospheric water generators are known which use the compressor driven refrigeration cycle system to cool air below the dew point. U.S. Pat. No. 5,259,203 describes such a system. U.S. Pat. No. 4,255,937 describes an electrically operated dehumidifier using standard refrigeration techniques which serves as a small scale water extractor. U.S. Pat. No. 5,857,344 describes a compressor driven refrigeration system used in a small scale water extractor. U.S. Pat. No. 6,705,104 also describes a compressor operated refrigeration system used to extract water from air. However, such systems use a large amount of electrical energy per litre of water extracted, and are generally not suitable for large scale water production plants.

It is desirable to provide a large scale water extraction system.

It is also desirable to provide a water extraction system which produces water at an economic cost.

Absorption chillers can use the properties of fluids, such as the latent heat of vaporization, to provide a cyclical endothermic or heat absorbing process. Energy can be input to the system using an energy source, such as electricity, gas, solar, waste heat, etc. One such system uses ammonia, hydrogen and water as the working fluids. A description of such a system can be found at http://www.gasrefrigerators.com/howitworks.htm

The mixed hydrogen vapour is then separated by using water to absorb the ammonia. The heat input is then used to separate the water and ammonia by evaporating the ammonia.

An alternative absorption chiller system uses a Li/Br salt solution to absorb water from the air.

Any reference herein to known prior art does not, unless the contrary indication appears, constitute an admission that such prior art is commonly known by those skilled in the art to which the invention relates, at the priority date of this application.

### SUMMARY OF THE INVENTION

The invention provides a water extraction system having a cooling system adapted to cool air to below the dew point, the cooling system including a closed refrigeration system and a heat exchanger and a collector to collect water, wherein the cooling system is an absorption chiller.

The chiller can be powered by gas.

The chiller can be powered by solar energy from a solar collector.

The system can include air flow generator adapted to cause air to flow through the heat exchanger.

The air flow generator can be controllable to control the air flow through the heat exchanger.

The heat exchanger can include a coolant pipe and cooling fins thermally connected the coolant pipe, wherein the surface area of the fins is enlarged to increase the contact between the air flow and the fins.

The system can include a dew point sensor to determine the dew point of the air.

The system can include a controller controlling the air flow generator to maintain the temperature of the air from the heat exchanger below the dew point.

The invention also provides a method of extraction water from air, the method including using an absorption chiller to cool an air/heat transfer fluid heat exchanger to a temperature below the dew point, and collecting water from the air/heat transfer fluid heat exchanger.

The method can include the step of using gas as a source of heat energy to operate the chiller.

The method can use the step of using solar energy as a source of heat to operate the chiller.

The system can be used to produce potable water by the addition of suitable filtration and other water treatment processes as required by the nature of the water generated from the water extraction system.

### BRIEF DESCRIPTION OF THE DRAWINGS

An embodiment or embodiments of the present invention will now be described, by way of example only, with reference to the accompanying drawings, in which:

FIG. 1 is a schematic illustration of a water extraction system according to a first embodiment of the invention.

FIG. 2 is a schematic illustration of a water extraction system according to a second embodiment of the invention.

FIG. 3 schematically illustrates an absorption chiller suitable for use in relation to the present invention.

FIG. 4 schematically illustrates a further arrangement embodying the invention.

FIG. 5 is a schematic functional block diagram of a system embodying the invention.

FIG. 6 is a functional block diagram of the water extraction system which forms part of the system of FIG. 5.

FIG. 7 illustrates a controller adapted for use in an embodiment of the invention.

The numbering convention used in the drawings is nn.nnn, or n.nnn, where the digits before the stop indicate the drawing number, and the digits after the stop indicate the item number. Where possible, the same item number is used in different figures to indicate the corresponding item.

### DETAILED DESCRIPTION OF THE EMBODIMENT OR EMBODIMENTS

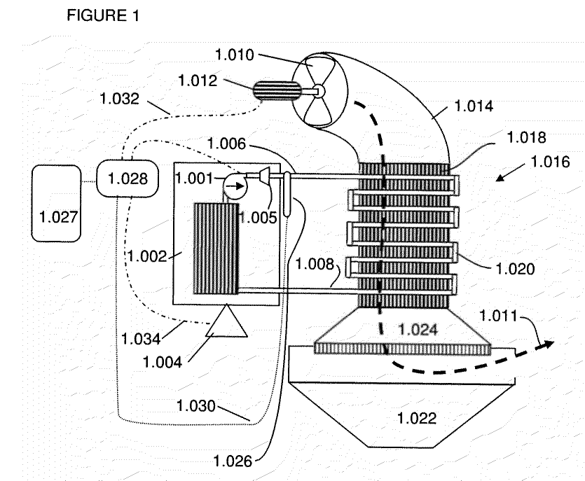

FIG. 1 shows a water extraction system according to a first embodiment of the invention.

An absorption chiller 1.002, a heat energy input 1.004, a heat transfer outlet pipe 1.006, a heat transfer fluid return pipe 1.008, a heat transfer fluid compressor 1.003, a fan 1.010, fan motor 1.012, air duct 1.014, a restrictor valve 1.015, an evaporator/heat exchanger 1.016 having fins 1.018 and heat transfer fluid pipe 1.020. The air path through the heat exchanger 1.016 emerges in cowling 1.024 located over water trough 1.022. A temperature sensor 1.026 senses the temperature at the outlet of the chiller. The sensor 1.026 is connected to a controller 1.028. The controller is connected to control the speed of the air flow by controlling the speed of the fan. The controller can also control the heat input 1.004.

The fans and pumps can be powered by electricity from the mains or from a sloar generator or other source of electrical power. In one embodiment, electrical power can be used as an alternative power source to operate the chiller. Further, a system can be provided having both gas power and electrical power for the chiller, with a programmable changeover based on the comparative tariffs or energy costs. The energy costs take account of the relative efficiencies of the gas and electrical systems. Thus the switchover can be based on the energy cost of electricity divided by the efficiency of the electrical chiller compared with the energy cost of gas divided by the gas efficiency. Thus, if the electrical cost is less than gas during an off-peak electrical supply period, the system can switch to electricity.

Optionally, a dew point monitor 1.027 can be connected to the controller. This enables the controller to determine the required chiller temperature or air cooling rate and the air flow rate from the fan. The dew point can be calculated by the controller from measurements of relative humidity and temperature.

In use, the fan delivers air to the heat exchanger 1.016 at a first flow rate. The dotted line arrow 1.011 indicates the air flow through the system. Because this exhaust air is chilled, it can be used to deliver cool, de-humidified air to a building. The absorption chiller operates to cool the heat transfer fluid (HTF) which is delivered to the heat exchanger so that the output air from the heat exchanger is below the dew point. Where the humidity is low, the air flow rate from the fan can be decreased. When the dew point falls below a selected threshold, the water generating function can be discontinued by the controller. We have found that, for a gas fired chiller, the cut-off threshold dew point temperature can be as low as about 0.5° C. (33° F.), while, for electrical chillers, a cut-off dew point temperature of about 7° C. (45° F.) an be used to keep down the cost of electricity consumed.

Preferably, the cooling fins 1.018 have an upright orientation to assist the flow of water into the collector 1.022. The fins need not be vertical, but are preferably at an angle of less than 45° to the vertical.

The heat transfer fluid compressor 1.003 can be controlled on an ON/OFF mode.

The controller can be programmed to control the outlet temperature from the air/heat transfer fluid heat exchanger to a few degrees below the dew point to increase the rate of condensation. This temperature is referred to as the set point.

Set point=dew point-ΔT, where ΔT is a predetermined temperature below the dew point.

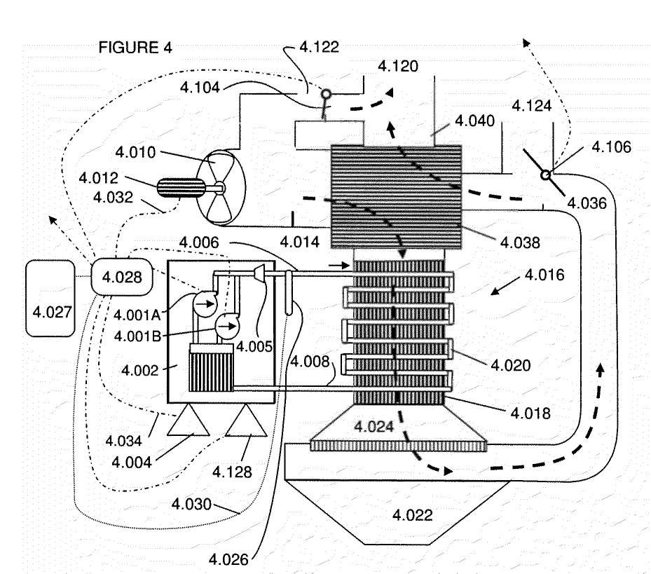

Thus, by controlling the air flow, the temperature, the rate of condensation can be controlled. Optionally, the operation of the compressor 1.003 can also be controlled to optimize the operation of the system. However, as compressors are designed to operate at a particular speed, alternative methods of providing compressed HTF can be used, for example by using two or more compressors as described below with reference to FIG. 4. The individual compressors can be switched on or off as required to achieve the required cooling rate.

The controller can be programmed to prevent the condensate on the fins of the air/heat transfer fluid heat exchanger from freezing. However, because the air is travelling at a significant flow rate, the temperature of the heat transfer fluid can be of the order of −5° C. to −10° C. The upper temperature can be set to below the dew point, which, in some cases can be +10° C. or higher. In one embodiment, the controller can be set to maintain the temperature between −5° C. and +6° C. This temperature range provides a thermal hysteresis which means that the gas burner can be operated intermittently rather than continuously if the temperature were set closer to the dew point. Thus the gas burner can have a variable duty cycle determined by the dew point.

Preferably, the air flow in the air/heat transfer fluid heat exchanger is in a top-to-bottom direction, or at least inclined to assist the downward flow of the water condensed from the atmosphere.

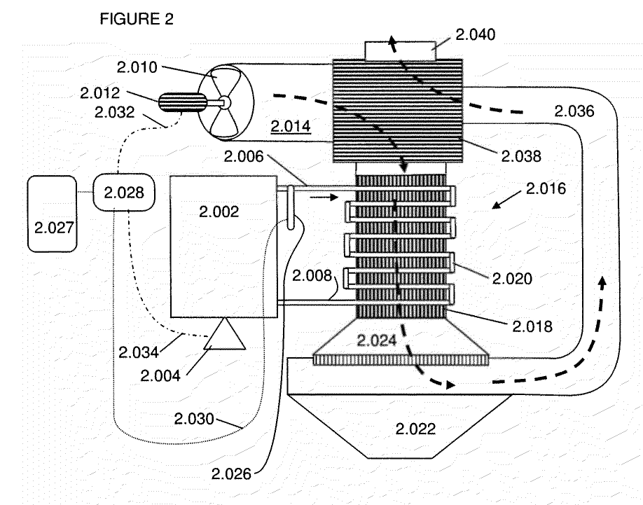

FIG. 2 illustrates a modified version of the system of FIG. 1, in which corresponding elements have the same item numbers as in FIG. 1.

The system of FIG. 2 includes an air/air heat exchanger 2.038 connected by ducting 2.036 to the outlet 2.024 of the air/heat transfer fluid heat exchanger 2.016. The air flow output from the fan 2.010 is directed into the air/air heat exchanger 2.038 and gives up heat to the cool air flow delivered from the air/heat transfer fluid heat exchanger 2.016. The pre-cooled air flow from the fan then enters the air/heat transfer fluid heat exchanger, and the “dehydrated” exhaust air exits via vent 2.040. This reduces the cooling work required from the chiller 2.002. This exhaust air is still below the ambient air temperature and can be used to cool a building.

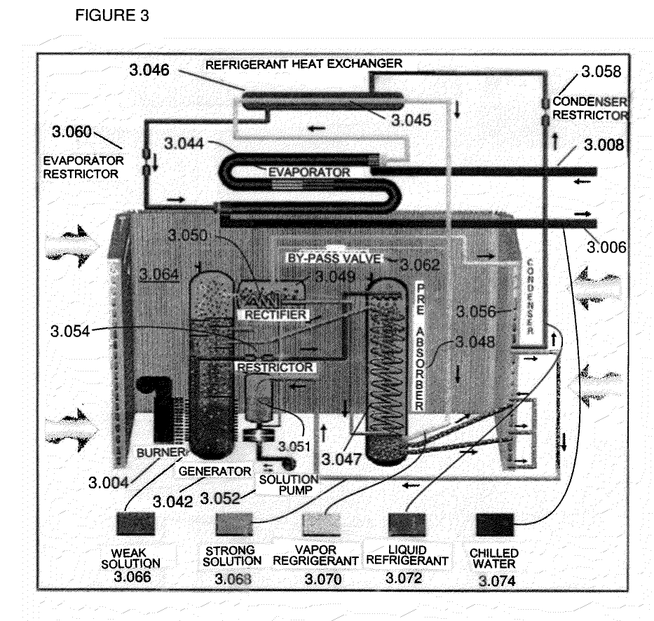

FIG. 3 illustrates an absorption chiller producing chilled water at 3.006, returning via 3.008. The water can include an anti-freeze solution to enable it to operate at sub-zero temperatures. The working fluid can be ammonia.

Working solution path is as follows: solution pump 3.052, rectifier 3.050, pre-absorber coil 3.047, generator 3.042, at which point the light and heavy constituents split.

The heavy constituents take a path through restrictor 3.054, pre-absorber 3.048, condenser 3.056, solution chamber 3.051.

The lighter constituents take a path through generator 3.042; rectifier tank 3.049, pre absorber 3.048, condenser 3.056 and thence to the solution tank 3.051.

Vapour refrigerant exits the rectifier tank 3.050, to condenser 3.056, condenser restrictor 3.058, jacket of refrigerant hex 3.046, evaporator restrictor 3.060, evaporator 3.044 internal refrigerant heat exchanger 3.045, and to the pre-absorber 3.048, where it merges with the heavier constituents from the generator 3.042.

FIG. 4 illustrates an atmospheric water extraction system according to a further embodiment of the invention. Specific changes in this system compared with the arrangement of FIG. 2 include two or more compressors 4.001A and 4.001B, an additional chiller power source 4.128, together with ducting 4.120, 4.124 and dampers 4.104, 4.016 adapted to use part or all of the air intake and part or all of the air outlet for air conditioning a building.

In one embodiment, the compressors can have individual air/htf heat exchangers.

The compressors are controllable so the amount of power used by the chiller operation can be varied. This is particularly useful when using electrical power. The system operates under the control of the controller 4.028. For example, in the case of a system having three compressors, on startup of the electrical system, all the compressors are used to bring the chiller to the set point. Then number 3 compressor can be switched off, and if the temperature falls below the set point, number 2 compressor is switched off, leaving number 1 compressor to maintain the temperature within a specified temperature range around the set point. The number 2 and 3 compressors can then be used as required depending on atmospheric conditions to maintain the system within the operating range. Thus the higher the dew point, the less cooling energy is required.

In one embodiment, the set point can be determined in the factory, and may be determined by the use of information relating to the locality into which the system is to be installed. Optionally a number of set points can be programmed into the controller to take account of seasonal variations.

In one embodiment, in an electrically operated mode, the set point can be of the order of 5° C., while in the gas operated mode, the set point can be of the order of 0.5° C.

In a further embodiment, the controller can actively calculate the set point based on the prevailing atmospheric conditions, such as temperature, humidity, dew point.

When the system is powered by gas, full power is used to bring the system to a temperature below the set point, and the gas can then be turned off so the system uses its thermal hysteresis to continue operating until the temperature rises to the set point, and the gas is again applied.

The fan speed is controllable by the controller in response to the performance of the system in the prevailing atmospheric conditions. For example, the fan speed can be varied in response to changes in the atmospheric dew point. Thus the optimum air flow across the air/htf heat exchanger to be maintained. If the dew point falls below a predetermined threshold temperature, water making is discontinued.

The controller looks at the Dew Point temp/Enthalpy/Dry Bulb temperatures (Entering air & Leaving air) to make calculations and adjustment in fan speed. Fan speed control is based on an algorithm to maximize dehumidification based on entering dry bulb and dew point temperatures. This fan speed calculates approximate tonnage to maximize efficiency and maximize water extraction based on standard energy equation Qt=4.5 CFM (H1-H2) where H is enthalpy of entering and leaving air. The CFM is increased to keep Qt as close to maximum tonnage as chiller/absorber is capable of producing. The controller then sends appropriate signal to Variable Frequency Drive to modify fan RPM an in turn CFM produced.

The controller can be selectively controlled by a keyboard or other input to operate the system in a number of different operational modes, such as water extraction only, air conditioning only, or water extraction and air conditioning combined.

Ducting and dampers as shown in FIG. 4 can be added to control the flow of air from the system into a building. Damper 4.104 is adapted to divert air from the fan 4.010 to vent 4.122 or to an air conditioning duct 4.120. damper 4.106 can block flow through the chiller, or divert flow from the chiller either through air/air heat exchanger 4.038 or to duct 4.124. The dampers can be controlled by the controller 4.028.

The additional power source can be, for example, electrical mains power. The controller can select the power source.

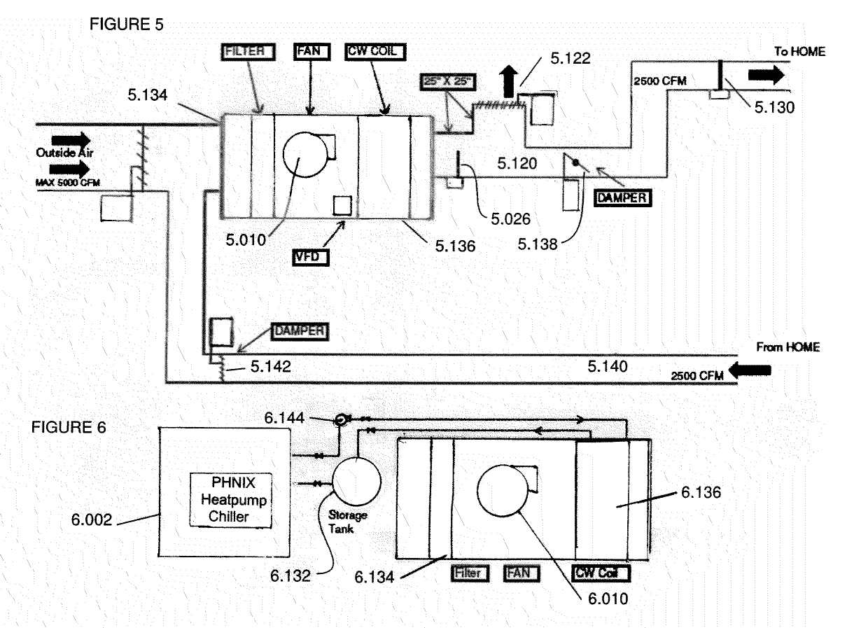

FIG. 5 is a functional block diagram of the air conditioning system of a system according to an embodiment of the invention. The fan 5.010 draws air through filter 5.134 and odirects it to CW coil 5.136 whence it enters duct 5.120 for delivery to the air conditioned building. Exhaust vent 5.122 is controllable to divert air from the building duct when damper 5.138 is closed. An air flow sensor 5.130 reports the air flow rate to the controller. A return duct 5.140 returns air to the inlet, controllable by damper 5.142.

FIG. 6 is a functional block diagram of the water extraction system which forms part of the system of FIG. 5. The fan 6.010 filter 6.134 and CW coil 6.136 correspond to the same elements in FIG. 5. The heat pump chiller 6.002 delivers cool wate rto the CW coil via pump 6.144 and the water is then delivered to the storage tank 6.132.

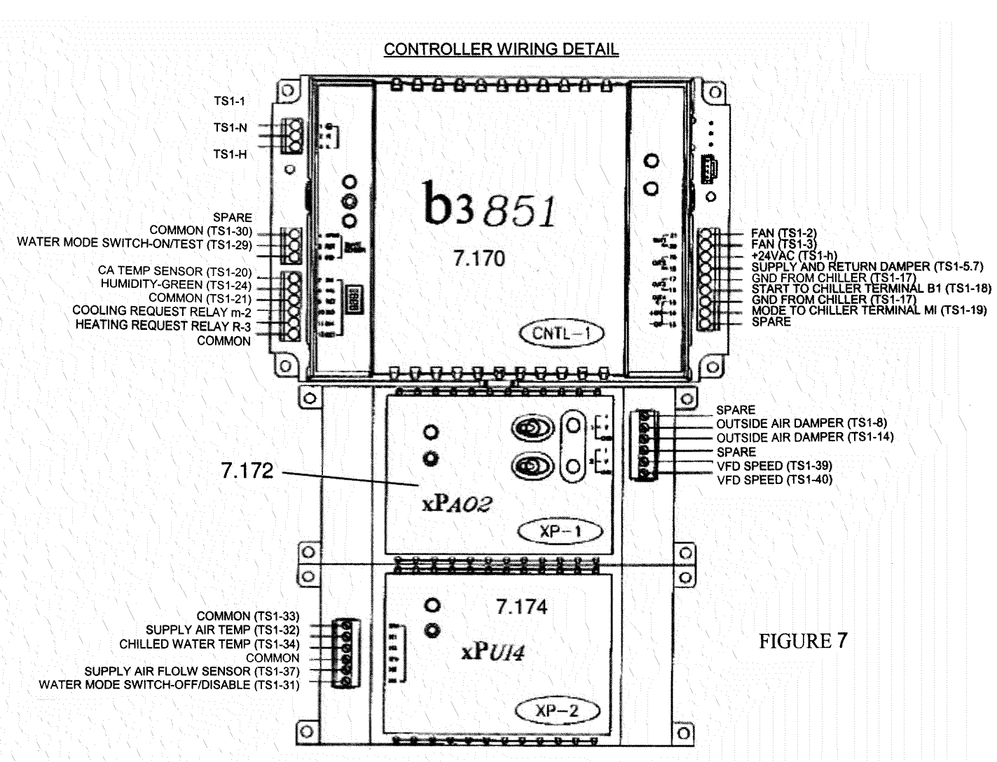

FIG. 7 illustrates a controller adapted for use in an embodiment of the invention. The controller 7.170 can be, for example, an Andover B3 851 with an analog output module 7.172 and a universal input module 7.174.

A commercially available absorption chiller, such as the Robur 5 Ton Absorption Chiller, can be used to implement an embodiment of the invention. The specification for a chiller and air handler used in an embodiment of the invention are set out below.

Specifications of the 5 Ton Gas Fired Chiller HP5T

| | |
|---|---|
| Voltage | 240 V |
| Cooling capacity | 16 kW |
| Gas consumption @26% | 67 cubic meter/hour. |
| Total electric load (constant | 540 watts. |
| running) | |
| Weight | 276 KG |
| Dimensions | 850 w × 655d × 1310 h. |
| Noise level | 49 db |

Specifications of the Air Handler HP16 Kw

| | |
|---|---|
| Voltage | 240 V |
| Cooling capacity | 17 Kw |
| Electrical fans (2) | 240 watts and 120 watts |
| Weight | 160 KGs |
| Dimensions (horizontal) | 1300 w × 600 d × 710 w |
| Coil coated with anti corrosive coatings | |
| Filter from water collection tank to storage tank | |
| if required. | |
| Circulation pump (s) | |
| ‘Manufactured water’ Transfer pump | |
| Water manufacturing ability at 50% humidity | 17 Liters/hour |
| and 26° C. | |

The system can be scaled up to provide large scale water extraction capabilities. An air handler system capable of providing efficient cooling includes a sufficiently large fin area to ensure efficient cooling of the air below the dew point.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A water extraction system having a cooling system adapted to cool air to below the dew point, the cooling system including an absorption chiller system including a heat source, the system including an air/heat transfer fluid heat exchanger, and a water collector arranged to collect water from the air/heat transfer fluid heat exchanger.

2. A water extraction system as claimed in claim 1, wherein the heat source is a gas burner.

3. A water extraction system as claimed in claim 1, wherein the heat source is solar energy.

4. A water extraction system as claimed in claim 1, including an air flow generator adapted to cause air to flow through the air/heat transfer fluid heat exchanger.

5. A water extraction system as claimed in claim 4, wherein the air flow generator is controllable to control the air flow through the heat exchanger.

6. A water extraction system as claimed in claim 1, wherein the heat exchanger includes a coolant pipe and cooling fins thermally connected the coolant pipe, wherein the surface area of the fins is enlarged to increase the time the contact surface between the air flow and the fins.

7. A water extraction system as claimed in claim 1, including a dew point sensor to determine the dew point of the air.

8. A water extraction system as claimed in claim 1, including a controller controlling the air flow generator to maintain the temperature of the air from the heat exchanger below the dew point.

9. A water extraction system as claimed in claim 8, wherein, in use, the controller is adapted to control the heat source to maintain the outlet temperature of the heat exchanger below the dew point.

10. A water extraction system as claimed in claim 1, including an additional chipper power supply.

11. A water extraction system as claimed in claim 9, wherein the additional power source is an electrical power supply.

12. A water extraction system as claimed in claim 1, wherein the chiller system includes two or more selectively switchable compressors.

13. A method of extraction water from air, the method including using an absorption chiller to cool an air/heat transfer fluid heat exchanger to a temperature below the dew point, and collecting water from the air/heat transfer fluid heat exchanger.

14. A method as claimed in claim 13, including the step of using gas as a source of heat energy to operate the chiller.
